(19) United States
(12) Patent Application Publication
(10) Pub. No.: US 2026/0219600 A1
(43) Pub. Date: Jul. 30, 2026

(54) IMAGE FORMING APPARATUS

(71) Applicant: KYOCERA Document Solutions Inc., Osaka (JP)

(72) Inventors: Hiroshi Nakagawa, Osaka (JP); Kenji Takai, Osaka (JP)

(21) Appl. No.: 19/440,003

(22) Filed: Jan. 5, 2026

(30) Foreign Application Priority Data
Jan. 24, 2025 (JP) 2025-010540

(51) Int. Cl. G03G 15/08; G03G 15/00; G03G 21/16

(52) U.S. Cl. CPC G03G 15/0863; G03G 15/0856; G03G 15/556; G03G 21/1633; G03G 21/1676; G03G 2215/0695; G03G 2221/163; G03G 2221/169

(57) ABSTRACT

A control device selects one target attachment portion from a plurality of attachment portions and selects the new target attachment portion in a predefined order whenever a sense state of a remaining-amount sensing device for a target storing unit attached to the target attachment portion changes from a developer-present state to a developer-empty state. An attachment sensing device senses an attachment state in which a plurality of developer storing units is attached to the plurality of respective attachment portions. A replacement operation sensing device senses a replacement operation on any of the plurality of developer storing units. The control device outputs a replacement error notification to a display device in a case where an attachment sensing condition that the attachment state of the target attachment portion is sensed by the attachment sensing device is not established when the replacement operation is sensed.

### INCORPORATION BY REFERENCE

This application is based upon and claims the benefit of priority from the corresponding Japanese Patent Application No. 2025-010540 filed on January 24, 2025, the entire contents of which are incorporated herein by reference.

### BACKGROUND

This disclosure relates to an image forming apparatus. It is possible to attach a plurality of developer storing units to the image forming apparatus. The plurality of developer storing units stores developers of the same colors.

An image forming apparatus includes one or more attachment portions to which developer units that store developers are attached. For example, in a case where the image forming apparatus is capable of executing a color print process, the image forming apparatus includes a plurality of attachment portions corresponding to a plurality of developed colors.

In addition, an image forming apparatus has been known that allows two toner containers to be attached thereto for respective toners of each of the four colors of yellow, magenta, cyan, and black. It is noted that each of the toners is an example of a developer. Each of the toner containers is an example of the developer storing unit.

In a case where the image forming apparatus includes two attachment portions for each of the developed colors, there is no downtime during which it is not possible to execute a print process even while the developer storing unit is being replaced.

### SUMMARY

An image forming apparatus according to an aspect of this disclosure includes a printing device, a plurality of attachment portions, a remaining-amount sensing device, a control device, an attachment sensing device, and a replacement operation sensing device. The printing device forms an image on a sheet. The plurality of attachment portions is portions to which a plurality of respective developer storing units is attachable. The plurality of developer storing units stores developers of the same color. The developers are each supplied to the printing device. The remaining-amount sensing device senses an amount of the developer remaining in each of the plurality of developer storing units attached to the plurality of attachment portions. The control device selects one target attachment portion from the plurality of attachment portions and selects the new target attachment portion in a predefined order whenever a sense state of the remaining-amount sensing device for a target storing unit attached to the target attachment portion among the plurality of developer storing units changes from a developer-present state to a developer-empty state. The target attachment portion is a supply source of the developer for the printing device. The attachment sensing device senses an attachment state in which the plurality of developer storing units is attached to the plurality of respective attachment portions. The replacement operation sensing device senses a replacement operation on any of the plurality of developer storing units in any of the plurality of attachment portions. The control device outputs a replacement error notification to a display device in a case where an attachment sensing condition that the attachment state of the target attachment portion is sensed by the attachment sensing device is not established when the replacement operation is sensed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a block diagram illustrating a configuration of a control device in the image forming apparatus according to the embodiment.

FIG. 3 is a configuration diagram of a toner supply portion in the image forming apparatus according to the embodiment.

FIG. 4 is a flowchart showing an example of a procedure of a target selection process by the image forming apparatus according to the embodiment.

FIG. 5 is a flowchart showing an example of a procedure of a container replacement confirmation process by the image forming apparatus according to the embodiment.

FIG. 6 is a flowchart showing an example of a procedure of an attachment guidance process by the image forming apparatus according to the embodiment.

FIG. 7 is a diagram showing an example of an attachment target identification screen that is displayed on the image forming apparatus according to the embodiment.

### DETAILED DESCRIPTION

Hereinafter, an embodiment of this disclosure will be described with reference to the drawings. It is noted that the following embodiment is a specific example of this disclosure and does not limit the technical scope of this disclosure.

### Configuration of Image Forming Apparatus 10

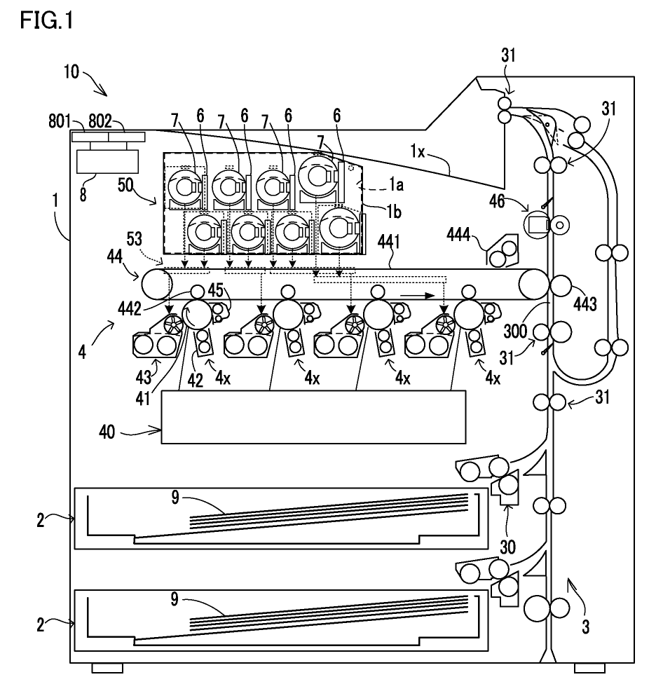

An image forming apparatus 10 according to the embodiment is capable of executing a print process of forming an image on a sheet 9. The image forming apparatus 10 shown in FIG. 1 is a printer. It is noted that the image forming apparatus 10 may be a copying machine, a facsimile apparatus, a multifunction peripheral, or the like.

As shown in FIG. 1, the image forming apparatus 10 includes a main housing 1, sheet storing portions 2, a conveying device 3, a printing device 4, a toner supply portion 50, a control device 8, an operation device 801, and a display device 802.

The main housing 1 is a housing that houses the conveying device 3, the printing device 4, the toner supply portion 50, and the control device 8. There is also provided a conveyance path 300 in the main housing 1. The conveyance path 300 is the path of the sheet 9.

The conveying device 3 includes a sheet feeding mechanism 30 and a plurality of conveying roller pairs 31. The sheet feeding mechanism 30 feeds the sheets 9 stored in the sheet storing portions 2 to the conveyance path 300 one by one.

The plurality of conveying roller pairs 31 conveys the sheets 9 along the conveyance path 300. One of the plurality of conveying roller pairs 31 discharges the sheet 9 on which an image is formed by the printing device 4 onto a discharge tray 1x from the conveyance path 300.

The printing device 4 executes the print process on the sheet 9 conveyed along the conveyance path 300. The print process is a process of forming an image on the sheet 9. In the example shown in FIG. 1, the printing device 4 electrophotographically executes the print process.

The electrophotographic printing device 4 includes an exposure device 40, one or more image forming portions 4x, a transfer device 44, and a fixing device 46. The printing device 4 shown in FIG. 1 is a tandem-type color printing device. In this case, the printing device 4 includes the plurality of image forming portions 4x corresponding to a plurality of developed colors.

In the example shown in FIG. 1, the printing device 4 includes the four image forming portions 4x corresponding to the developed colors of yellow, magenta, cyan, and black.

Each of the image forming portions 4x includes a photoconductor 41, a charging device 42, a developing device 43, and a first cleaning device 45. The photoconductor 41 rotates and the charging device 42 charges the surface of the photoconductor 41.

The exposure device 40 scans the charged surface of the photoconductor 41 with laser light to draw an electrostatic latent image on the surface of the photoconductor 41. The developing device 43 supplies toner to the surface of the photoconductor 41 to develop the electrostatic latent image into a toner image.

The transfer device 44 transfers the toner image on the surface of the photoconductor 41 to the sheet 9 conveyed along the conveyance path 300.

In the tandem-type printing device 4, the transfer device 44 includes an intermediate transfer belt 441, a plurality of primary transfer devices 442, a secondary transfer device 443, and a second cleaning device 444. The plurality of primary transfer devices 442 is provided in association with the plurality of image forming portions 4x.

The intermediate transfer belt 441 partially rotates along the plurality of image forming portions 4x. The plurality of primary transfer devices 442 transfers the toner images on the surfaces of the photoconductors 41 of the plurality of image forming portions 4x to the surface of the intermediate transfer belt 441. This forms, on the surface of the intermediate transfer belt 441, a color toner image in which the toner images of the plurality of colors are combined.

The secondary transfer device 443 transfers the color toner image on the surface of the intermediate transfer belt 441 to the sheet 9. The fixing device 46 heats and pressurizes the color toner image on the sheet 9 to fix the color toner image onto the sheet 9.

The toner supply portion 50 supplies toners to the developing devices 43 of the plurality of image forming portions 4x in the printing device 4. The toner supply portion 50 includes a plurality of attachment portions 5. The plurality of attachment portions 5 is portions to which a plurality of respective toner containers 7 is detachably attached.

The main housing 1 includes an opening 1a and a cover 1b (see FIGS. 1 and 3). The opening 1a exposes the plurality of attachment portions 5 to the outside. The cover 1b closes the opening 1a. The cover 1b is supported so as to be movable between a closed position and an open position. The cover 1b closes the opening 1a at the closed position. The cover 1b opens the opening 1a at the open position.

When the cover 1b is open, it is possible to access the respective attachment portions 5 from the outside of the main housing 1. That is, when the cover 1b is held at the open position, it is possible to attach and detach the toner containers 7 to the respective attachment portions 5.

The toner supply portion 50 supplies the toners in the plurality of toner containers 7 attached to the plurality of attachment portions 5 to the developing devices 43 of the plurality of image forming portions 4x for the respective developed colors.

It is noted that the sheet 9 is a sheet-shaped image forming medium such as a paper sheet. Each of the toners is an example of a developer. Each of the toner containers 7 is an example of a developer storing unit that stores a developer.

The operation device 801 is a device that receives a human operation. For example, the operation device 801 includes one or both of a touch panel and an operation button.

The display device 802 is capable of displaying various kinds of information. For example, the display device 802 is a panel display device such as a liquid-crystal display device. The control device 8 controls various electrical devices included in the image forming apparatus 10.

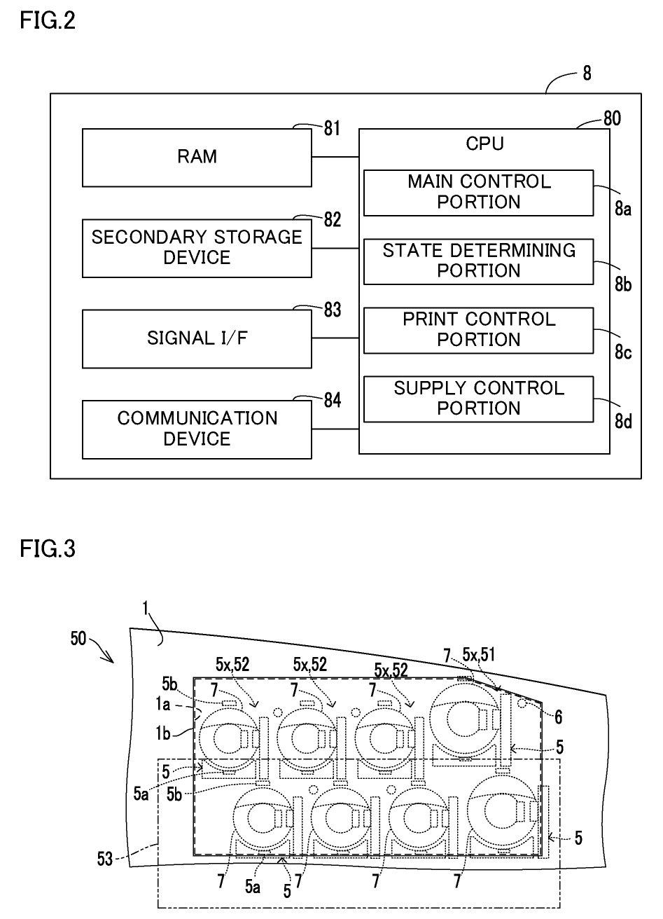

As shown in FIG. 2, the control device 8 includes a central processing unit (CPU) 80, a random access memory (RAM) 81, a secondary storage device 82, a signal interface 83, a communication device 84, and the like.

The CPU 80 executes various kinds of control and data processes by executing computer programs. The RAM 81 temporarily stores the computer programs executed by the CPU 80 and various kinds of data.

The secondary storage device 82 is a computer-readable non-volatile storage device. The secondary storage device 82 stores the computer programs executed by the CPU 80 and the various kinds of data. For example, one of a flash memory or a hard disk drive or both of the flash memory and the hard disk drive are adopted as the secondary storage device 82.

The signal interface 83 converts sense signals of various sensors into digital sense data. The sense data is transmitted to the CPU 80.

The communication device 84 executes communication with a plurality of external apparatuses including one or more host apparatuses through a network. The CPU 80 executes communication with each of the external apparatuses through the communication device 84. Each of the host apparatuses is an information processing apparatus that requests the image forming apparatus 10 to execute the print process.

The CPU 80 includes a plurality of processing modules implemented by executing the computer programs. The plurality of processing modules includes a main control portion 8a, a state determining portion 8b, a print control portion 8c, a supply control portion 8d, and the like (see FIG. 2).

The main control portion 8a executes a process of receiving various requests and control to cause another module to execute a process corresponding to a request. For example, the main control portion 8a receives a print request through the operation device 801 or the communication device 84. Furthermore, the main control portion 8a causes the print control portion 8c to execute a process corresponding to the print request.

The state determining portion 8b determines the various states of the image forming apparatus 10 depending on the sense states of the various sensors and the operation states of various devices in the image forming apparatus 10.

The print control portion 8c controls the conveying device 3 and the printing device 4. The print control portion 8c causes the printing device 4 to execute the print process while causing the conveying device 3 to convey the sheet 9.

The supply control portion 8d controls the toner supply portion 50 to control the supply of toner from the toner supply portion 50 to the printing device 4. The supply control portion 8d also executes a process for replacing the respective toner containers 7.

In this embodiment, the toner supply portion 50 includes the two attachment portions 5 for each of the plurality of developed colors (see FIG. 3). The toner supply portion 50 includes the two attachment portions 5 for respective toners of each of the four colors of yellow, magenta, cyan, and black.

In other words, it is possible to attach, to the toner supply portion 50, the two toner containers 7 that store toners of the same color to be supplied to the printing device 4. The downtime is not therefore caused even while one of the two toner containers 7 is being replaced for each of the developed colors in the image forming apparatus 10.

Specifically, the toner supply portion 50 includes four attachment portion sets 5x (see FIG. 3). The four respective attachment portion sets 5x correspond to toners of yellow, magenta, cyan, and black. Yellow, magenta, cyan, and black are respective examples of a developed color.

The four attachment portion sets 5x each include the two attachment portions 5. The toner supply portion 50 thus includes the eight attachment portions 5. In each of the four attachment portion sets 5x, the two toner containers 7 that store toners of the same color are attached to the two attachment portions 5.

The four attachment portion sets 5x include one black attachment portion set 51 corresponding to black toners and three color attachment portion sets 52 corresponding to three color toners (see FIG. 3). The three color attachment portion sets 52 correspond to yellow, magenta, and cyan.

In the example shown in FIG. 3, the two toner containers 7 attached to the one black attachment portion set 51 have larger toner storage capacity than that of each of the three pairs of toner containers 7 attached to the three color attachment portion sets 52.

The toner supply portion 50 further includes a supply mechanism 53, eight remaining-amount sensors 5a corresponding to the eight attachment portions 5, and eight attachment sensors 5b corresponding to the eight attachment portions 5 (see FIG. 3).

As described below, one of the two attachment portions 5 is selected as a target attachment portion for each of the four attachment portion sets 5x. The following description refers to one of the two toner containers 7 attached to the target attachment portion in each of the four attachment portion sets 5x as target container. The target container is an example of a target storing unit.

The supply mechanism 53 supplies toner to the corresponding developing device 43 from the target container for each of the four attachment portion sets 5x. That is, the target attachment portion is a supply source of toner for the printing device 4 in each of the four attachment portion sets 5x.

The eight remaining-amount sensors 5a can also be considered the four pairs of remaining-amount sensors 5a corresponding to the four attachment portion sets 5x.

The eight remaining-amount sensors 5a sense the amounts of toners remaining in the eight respective toner containers 7 attached to the eight attachment portions 5. For example, each of the remaining-amount sensors 5a is a magnetic permeability sensor.

It is noted that each of the remaining-amount sensors 5a may be a photosensor which senses the storage level of toner in the toner container 7. In addition, each of the remaining-amount sensors 5a may be a load cell that measures the weight of the toner container 7.

The one pair of remaining-amount sensors 5a corresponding to each of the attachment portion sets 5x, the two pairs of photosensors corresponding to each of the attachment portion sets 5x, and the two load cells corresponding to each of the attachment portion sets 5x are respective examples of a plurality of remaining-amount sensing devices.

The state determining portion 8b determines the amount of toner remaining in each of the toner containers 7 attached to the respective attachment portions 5 on the basis of a result of sensing by the remaining-amount sensor 5a. In this embodiment, the state determining portion 8b determines in which of a toner-empty state and a toner-present state each of the toner containers 7 is.

The toner-present state is a state in which there is toner remaining in the toner container 7. In contrast, the toner-empty state is a state in which there is no toner remaining in the toner container 7. The toner-present state is an example of a developer-present state and the toner-empty state is an example of a developer-empty state.

The following description refers to one of the four pairs of remaining-amount sensors 5a corresponding to the target attachment portion as target remaining-amount sensors.

The supply control portion 8d causes the supply mechanism 53 to execute an operation of supplying the toner in the target container to the developing device 43 under the condition that the toner-present state is being sensed by any of the target remaining-amount sensors.

That is, the supply mechanism 53 executes an operation of supplying the toner in the target container to the developing device 43 under the condition that the toner-present state of the target container is being sensed.

The toner supply portion 50 includes the two attachment sensors 5b for each of the four attachment portion sets 5x. The eight respective attachment sensors 5b are examples of an attachment sensing device that senses in which of an attachment-present state and a non-attachment state each of the eight attachment portions 5 is.

The attachment-present state of each of the attachment portions 5 is a state in which the toner container 7 is attached to the attachment portion 5. The non-attachment state of each of the attachment portions 5 is a state in which the toner container 7 is not attached to the attachment portion 5.

For example, each of the attachment sensors 5b is a reflective photosensor that emits light to the toner container 7 attached to the attachment portion 5 and senses reflection light.

In addition, each of the attachment sensors 5b may be a contact micro-switch or the like that senses the toner container 7 by bringing the toner container 7 into contact with the attachment portion 5.

Incidentally, a user of the image forming apparatus 10 replaces each of the toner containers 7 when the toner-empty state of the toner container 7 is sensed.

In a case where the image forming apparatus 10 includes the plurality of attachment portions 5 for each of the developed colors, there is a need to select supply sources of toners of each developed color from the plurality of attachment portions 5 in a predefined order.

The plurality of respective attachment portions 5 is hereby used with even frequency. As a result, such a situation is avoided that some of the plurality of attachment portions 5 deteriorate more significantly than the other attachment portions 5.

Meanwhile, the user may attach the new toner containers 7 to the plurality of attachment portions 5 for each of the developed colors in a wrong order.

In this embodiment, the supply control portion 8d executes a process for providing assistance such that the plurality of toner containers 7 which stores toners of the same colors is attached to the plurality of attachment portions 5 in the predefined order and the print process is then performed.

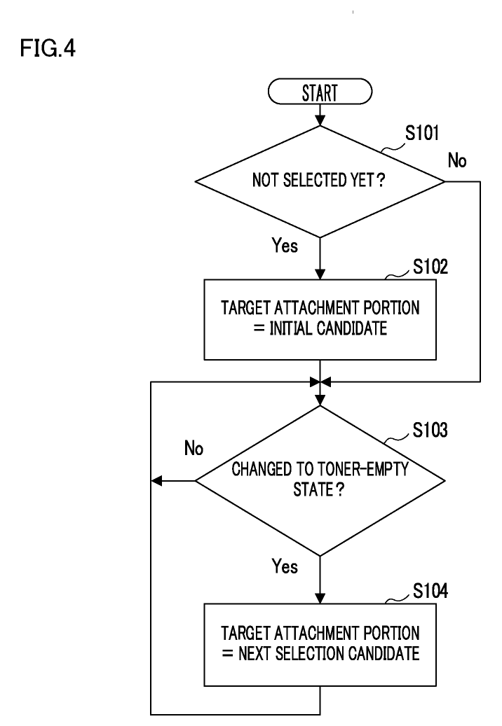

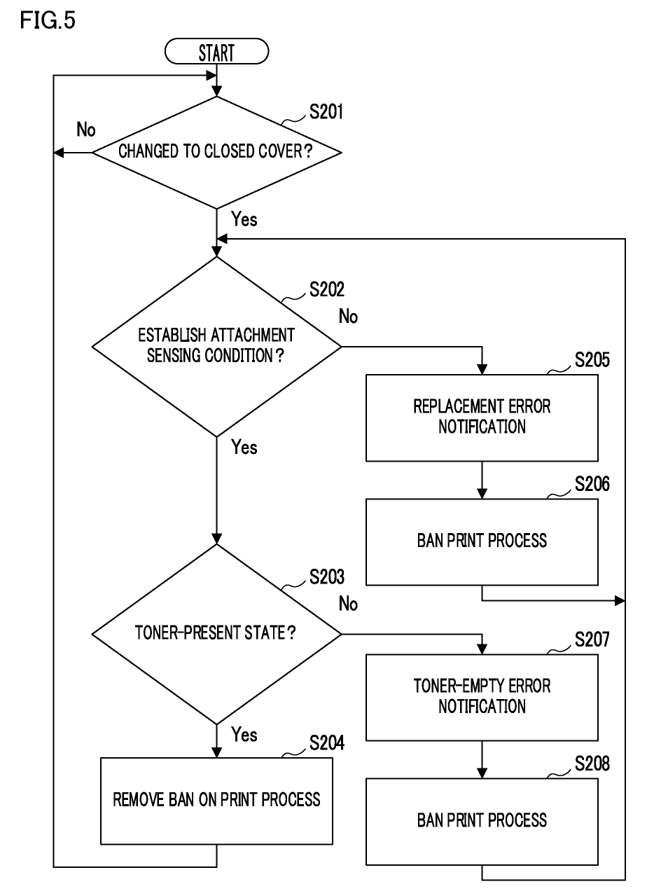

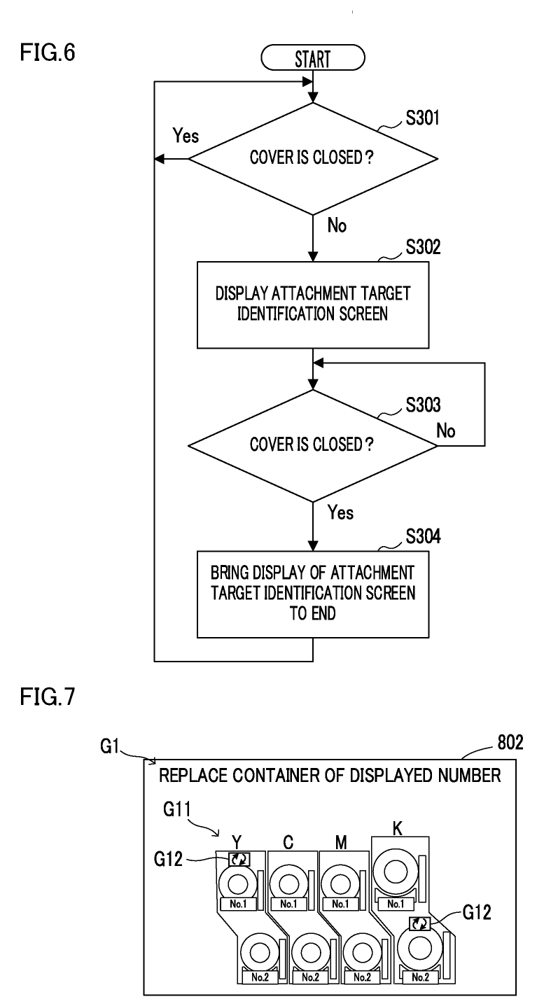

Specifically, the supply control portion 8d executes a target selection process and a container replacement confirmation process (see FIGS. 4 and 5). Furthermore, the supply control portion 8d also executes a container attachment guidance process (see FIG. 6).

When the image forming apparatus 10 is started, the supply control portion 8d starts the target selection process, the container replacement confirmation process, and the container attachment guidance process.

The image forming apparatus 10 further includes a cover sensor 6 (see FIG. 3). The cover sensor 6 is an example of a cover closing sensing device that senses a cover closed state in which the cover 1b is located at the closed position.

For example, the cover sensor 6 is a reflective photosensor that emits light to the cover 1b located at the closed position and senses reflection light. In addition, the cover sensor 6 may be a contact micro-switch or the like that comes into contact with the cover 1b located at the closed position to sense the cover 1b located at the closed position.

When the toner-empty state is sensed by any of the eight remaining-amount sensors 5a, the state determining portion 8b executes a toner-empty notification process. The toner-empty notification process is a process of causing the display device 802 to display information for identifying some or all of the eight attachment portions 5 the toner-empty state of which is being sensed.

When the toner-empty notification process is executed, a user opens the cover 1b and then replaces some or all of the eight toner containers 7 corresponding to the toner-empty state. Furthermore, the user closes the cover 1b.

An operation of closing the cover 1b thus indicates that a replacement operation is performed on any of the eight toner containers 7 in any of the eight attachment portions 5. That is, the replacement operation is an operation of moving the cover 1b from the open position to the closed position.

In this embodiment, the cover sensor 6 is an example of a replacement operation sensing device that senses the replacement operation. A change from a state in which the cover sensor 6 does not sense the cover closed state to a state in which the cover sensor 6 senses the cover closed state indicates that the replacement operation is sensed.

The supply control portion 8d selects the one target attachment portion from the two attachment portions 5 for each of the four attachment portion sets 5x. The supply control portion 8d selects the one target attachment portion for each of the four attachment portion sets 5x.

The following description refers to one of the two toner containers 7 attached to the target attachment portion in each of the attachment portion sets 5x as target container. In each of the attachment portion sets 5x, the target container serves as a supply source of toner by the supply mechanism 53.

### Target Selection Process

Hereinafter, examples of procedures of the target selection process will be described with reference to the flowchart shown in FIG. 4.

The supply control portion 8d executes the target selection process for each of the four attachment portion sets 5x.

In the following description, S101, S102, ... represent the identification signs of a plurality of steps in the target selection process. In the target selection process, the process of step S101 is first executed.

### Step S101

In step S101, the supply control portion 8d selects a next process depending on whether the target attachment portion has already been selected or has not yet been selected.

In a case where the target attachment portion has not yet been selected, the supply control portion 8d executes the process of step S102. In contrast, in a case where the target attachment portion has already been selected, the supply control portion 8d executes the process of step S103.

### Step S102

In step S102, the supply control portion 8d selects the initial candidate of the two attachment portions 5 in each of the attachment portion sets 5x as the target attachment portion. The initial candidate is the first selection candidate of the two attachment portions 5 defined in advance for each of the attachment portion sets 5x.

The supply control portion 8d executes the process of step S103 after executing the process of step S102.

### Step S103

In step S103, the supply control portion 8d monitors the sense state of the target remaining-amount sensor until the sense state of the target remaining-amount sensor changes from the toner-present state to the toner-empty state.

When the sense state of the target remaining-amount sensor changes from the toner-present state to the toner-empty state, the supply control portion 8d executes the process of step S104.

### Step S104

In step S104, the supply control portion 8d selects the next selection candidate from the two attachment portions 5 in each of the attachment portion sets 5x as the target attachment portion in accordance with the predefined order.

The supply control portion 8d executes the process of step S103 after executing the process of step S104.

As described above, the supply control portion 8d selects the one target attachment portion that is a supply source of toner for the printing device 4 from the two attachment portions 5 for each of the attachment portion sets 5x (see step S101).

Furthermore, the supply control portion 8d selects the new target attachment portion in the predefined order whenever the sense state of the target remaining-amount sensor changes from the toner-present state to the toner-empty state (see steps S103 to S104).

### Container Replacement Confirmation Process

Next, examples of procedures of the container replacement confirmation process will be described with reference to the flowchart shown in FIG. 5.

In the following description, S201, S202, ... represent the identification signs of a plurality of steps in the container replacement confirmation process. In the container replacement confirmation process, the process of step S201 is first executed.

### Step S201

In step S201, the supply control portion 8d monitors the sense state of the cover sensor 6 until the state in which the cover sensor 6 does not sense the cover closed state changes to the state in which the cover sensor 6 senses the cover closed state.

When the state in which the cover sensor 6 does not sense the cover closed state changes to the state in which the cover sensor 6 senses the cover closed state, the supply control portion 8d executes the process of step S202. That is, when the replacement operation is sensed by the cover sensor 6, the supply control portion 8d executes the process of step S202.

### Step S202

In step S202, the supply control portion 8d selects a next process depending on whether or not an attachment sensing condition is established for each of the attachment portion sets 5x.

The attachment sensing condition is a condition that the attachment state of the target attachment portion is sensed by one of the two attachment sensors 5b in each of the attachment portion sets 5x.

In a case where the attachment sensing condition is established, the supply control portion 8d executes the process of step S203. In a case where the attachment sensing condition is not established, the supply control portion 8d executes the process of step S205.

### Step S203

In step S203, the supply control portion 8d selects a next process depending on whether or not the toner-present state is sensed by any of the target remaining-amount sensors in each of the attachment portion sets 5x.

In a case where the toner-present state is sensed by any of the target remaining-amount sensors in each of the attachment portion sets 5x, the supply control portion 8d executes the process of step S204. In contrast, in a case where the toner-present state is not sensed by any of the target remaining-amount sensors in each of the attachment portion sets 5x, the supply control portion 8d executes the process of step S207.

### Step S204

In step S204, in a case where the print process by the printing device 4 is banned, the supply control portion 8d removes the ban on the print process.

As described below, the print process is banned in step S206 or S208 in some cases.

In a case where the print process by the printing device 4 is not banned or in a case where the ban on the print process is removed, the supply control portion 8d executes the process of step S201 and the subsequent processes.

### Step S205

Meanwhile, in step S205, the supply control portion 8d outputs a replacement error notification to the display device 802.

The replacement error notification is a notification indicating that the container in the target attachment portion of each of the attachment portion sets 5x is not appropriately replaced.

The supply control portion 8d executes the process of step S206 after executing the process of step S205.

### Step S206

In step S206, the supply control portion 8d bans the print process by the printing device 4. The supply control portion 8d executes the process of step S202 and the subsequent processes after executing the process of step S206.

The process of step S206 is executed to prevent the print process by the printing device 4 from being performed before the attachment sensing condition is established.

### Step S207

Meanwhile, in step S207, the supply control portion 8d outputs a toner-empty error notification to the display device 802.

The toner-empty error notification is a notification indicating that there is no toner remaining in the target container attached to the target attachment portion of each of the attachment portion sets 5x.

The supply control portion 8d executes the process of step S208 after executing the process of step S207.

### Step S208

In step S208, the supply control portion 8d bans the print process by the printing device 4 as in step S206. The supply control portion 8d executes the process of step S202 and the subsequent processes after executing the process of step S208.

The process of step S208 is executed to prevent the print process by the printing device 4 from being performed before a container filled with toner is attached to the target attachment portion of each of the attachment portion sets 5x.

As described above, in a case where the attachment sensing condition is not established when the replacement operation is sensed, the supply control portion 8d bans the operation of the printing device 4 until at least the attachment sensing condition is established (see steps S205 to S206).

Furthermore, even in a case where the attachment sensing condition is established when the replacement operation is sensed, the supply control portion 8d bans the operation of the printing device 4 until the target container the toner-present state of which is sensed is attached to the target attachment portion in each of the attachment portion sets 5x (see steps S207 to S208).

The container replacement confirmation process is an example of the process of providing assistance such that the two toner containers 7 which store toners of the same color are attached to the two attachment portions 5 in the predefined order for each of the attachment portion sets 5x and the print process is then performed.

### Container Attachment Guidance Process

Next, examples of procedures of the container attachment guidance process will be described with reference to the flowchart shown in FIG. 6.

In the following description, S301, S302, ... represent the identification signs of a plurality of steps in the container attachment guidance process. In the container attachment guidance process, the process of step S301 is first executed.

### Step S301

In step S301, in a case where the cover sensor 6 is sensing the cover closed state, the supply control portion 8d monitors the sense state of the cover sensor 6 until the cover sensor 6 no longer senses the cover closed state.

When the cover sensor 6 is not sensing the cover closed state, the supply control portion 8d executes the process of step S302.

### Step S302

In step S302, the supply control portion 8d causes the display device 802 to display an attachment target identification screen G1 (see FIG. 7).

The attachment target identification screen G1 includes an attachment portion schematic image G11 and an attachment target mark G12 (see FIG. 7). The attachment portion schematic image G11 shows schematic diagrams of the two attachment portions 5 in each of the four attachment portion sets 5x.

The attachment target mark G12 is a mark for identifying a specific attachment portion. The specific attachment portion is a target of the two attachment portions 5 to which the new toner container 7 is attached in each of the attachment portion sets 5x.

In this embodiment, the specific attachment portion is the target attachment portion to which the target container the toner-empty state of which is sensed is attached in each of the attachment portion sets 5x.

The attachment portion schematic image G11 and the attachment target mark G12 are examples of information that makes it possible to identify the target attachment portion of the two attachment portions 5 in each of the attachment portion sets 5x.

The supply control portion 8d executes the process of step S303 after executing the process of step S302.

### Step S303

In step S303, the supply control portion 8d monitors the sense state of the cover sensor 6 until the cover sensor 6 senses the cover closed state.

When the cover sensor 6 senses the cover closed state, the supply control portion 8d executes the process of step S304.

### Step S304

In step S304, the supply control portion 8d brings the display of the attachment target identification screen G1 on the display device 802 to an end.

The supply control portion 8d executes the process of step S301 and the subsequent processes after executing the process of step S304.

As described above, when the cover sensor 6 is not sensing the cover closed state, the supply control portion 8d outputs, to the display device 802, the information that makes it possible to identify the target attachment portion of the two attachment portions 5 in each of the attachment portion sets 5x.

The display device 802 is an example of an information output device. It is noted that the attachment target identification screen G1 may include the attachment target mark G12 corresponding to the target attachment portion in each of the attachment portion sets 5x regardless of the amount of toner remaining in the target container.

The container attachment guidance process is an example of the process of providing assistance such that the two toner containers 7 which store toners of the same color are attached to the two attachment portions 5 in the predefined order for each of the attachment portion sets 5x.

### First Modification

Next, a first modification of the image forming apparatus 10 will be described.

In this modification, a process of the supply control portion 8d is applied to an inkjet image forming apparatus. That is, in this modification, the printing device 4 executes the print process in an inkjet method.

The image forming apparatus according to this modification allows eight ink tanks to be attached thereto instead of the eight toner containers 7. The eight ink tanks each store ink. The ink is an example of the developer. The eight ink tanks are examples of the plurality of developer storing units.

The image forming apparatus according to this modification includes the four attachment portion sets 5x to which eight ink tanks are attached.

In a case where this modification is adopted, an effect similar to the effect obtained in a case where the image forming apparatus 10 is adopted is also obtained.

It is noted that a process of the supply control portion 8d may also be applied to an electrophotographic monochrome-image forming apparatus or an inkjet monochrome-image forming apparatus.

### Second Modification

Next, a second modification of the image forming apparatus 10 will be described.

The attachment portion sets 5x of the image forming apparatus according to this modification each include the three or more attachment portions 5. In this modification, the supply control portion 8d selects the one target attachment portion from the three or more attachment portions 5 for each of the attachment portion sets 5x.

In a case where this modification is adopted, an effect similar to the effect obtained in a case where the image forming apparatus 10 is adopted is also obtained.

### Third Modification

Next, a third modification of the image forming apparatus 10 will be described.

The image forming apparatus according to this modification includes eight light emitting elements disposed in the eight attachment portions 5. For example, each of the light emitting elements is an LED element.

The supply control portion 8d according to this modification executes a lighting process of turning on or blinking one light emitting element corresponding to the specific attachment portion among the two light emitting elements corresponding to the two attachment portions 5 in each of the attachment portion sets 5x in step S302 of the container attachment guidance process.

For example, the supply control portion 8d executes the lighting process instead of the process of causing the display device 802 to display the attachment target identification screen G1. Alternatively, the supply control portion 8d may execute both the process of causing the display device 802 to display the attachment target identification screen G1 and the lighting process.

The supply control portion 8d according to this modification turns off the two light emitting elements corresponding to the two attachment portions 5 in each of the attachment portion sets 5x in step S304 of the container attachment guidance process.

In this modification, the two light emitting elements in each of the attachment portion sets 5x are examples of the information output device.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:

a printing device configured to form an image on a sheet;

a plurality of attachment portions to which a plurality of respective developer storing units is attachable, the plurality of developer storing units being configured to store developers of a same color, the developers being each supplied to the printing device;

a remaining-amount sensing device configured to sense an amount of the developer remaining in each of the plurality of developer storing units attached to the plurality of attachment portions;

a control device configured to select one target attachment portion from the plurality of attachment portions and select the new target attachment portion in a predefined order whenever a sense state of the remaining-amount sensing device for a target storing unit attached to the target attachment portion among the plurality of developer storing units changes from a developer-present state to a developer-empty state, the target attachment portion being a supply source of the developer for the printing device;

an attachment sensing device configured to sense an attachment state in which the plurality of developer storing units is attached to the plurality of respective attachment portions; and

a replacement operation sensing device configured to sense a replacement operation on any of the plurality of developer storing units in any of the plurality of attachment portions, in which

the control device outputs a replacement error notification to a display device in a case where an attachment sensing condition that the attachment state of the target attachment portion is sensed by the attachment sensing device is not established when the replacement operation is sensed.

### Supplementary Note 2

The image forming apparatus according to Supplementary Note 1, including a housing configured to house the printing device and the plurality of attachment portions, the housing including an opening and a cover, the opening exposing the plurality of attachment portions to outside, the cover being movable between a closed position at which the cover closes the opening and an open position at which the cover opens the opening, in which

the replacement operation sensing device is a cover closing sensing device configured to sense a cover closed state in which the cover is located at the closed position, and

the replacement operation is an operation of moving the cover from the open position to the closed position.

### Supplementary Note 3

The image forming apparatus according to Supplementary Note 2, in which the control device outputs, to an information output device, information that allows the target attachment portion of the plurality of attachment portions to be identified when the cover closing sensing device is not sensing the cover closed state.

### Supplementary Note 4

The image forming apparatus according to any one of Supplementary Notes 1 to 3, in which the control device bans an operation of the printing device until at least the attachment sensing condition is established in a case where the attachment sensing condition is not established when the replacement operation is sensed.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a printing device configured to form an image on a sheet;
a plurality of attachment portions to which a plurality of respective developer storing units is attachable, the plurality of developer storing units being configured to store developers of a same color, the developers being each supplied to the printing device;
a remaining-amount sensing device configured to sense an amount of the developer remaining in each of the plurality of developer storing units attached to the plurality of attachment portions;
a control device configured to select one target attachment portion from the plurality of attachment portions and select the new target attachment portion in a predefined order whenever a sense state of the remaining-amount sensing device for a target storing unit attached to the target attachment portion among the plurality of developer storing units changes from a developer-present state to a developer-empty state, the target attachment portion being a supply source of the developer for the printing device;
an attachment sensing device configured to sense an attachment state in which the plurality of developer storing units is attached to the plurality of respective attachment portions; and
a replacement operation sensing device configured to sense a replacement operation on any of the plurality of developer storing units in any of the plurality of attachment portions, wherein
the control device outputs a replacement error notification to a display device in a case where an attachment sensing condition that the attachment state of the target attachment portion is sensed by the attachment sensing device is not established when the replacement operation is sensed.

2. The image forming apparatus according to claim 1, comprising a housing configured to house the printing device and the plurality of attachment portions, the housing including an opening and a cover, the opening exposing the plurality of attachment portions to outside, the cover being movable between a closed position at which the cover closes the opening and an open position at which the cover opens the opening, wherein
the replacement operation sensing device is a cover closing sensing device configured to sense a cover closed state in which the cover is located at the closed position, and
the replacement operation is an operation of moving the cover from the open position to the closed position.

3. The image forming apparatus according to claim 2, wherein the control device outputs, to an information output device, information that allows the target attachment portion of the plurality of attachment portions to be identified when the cover closing sensing device is not sensing the cover closed state.

4. The image forming apparatus according to claim 1, wherein the control device bans an operation of the printing device until at least the attachment sensing condition is established in a case where the attachment sensing condition is not established when the replacement operation is sensed.
